(19) United States
(12) Patent Application Publication
(10) Pub. No.: US 2022/0092488 A1
(43) Pub. Date: Mar. 24, 2022

(54) METHODS AND APPARATUS FOR IMPROVED SECURING OF RECREATIONAL VEHICLE TRAVEL ACCOMODATIONS

(71) Applicant: Mark Bradley Petersen, Marvin, NC (US)

(72) Inventor: Mark Bradley Petersen, Marvin, NC (US)

(21) Appl. No.: 17/480,679

(22) Filed: Sep. 21, 2021

Related U.S. Application Data
(60) Provisional application No. 63/080,815, filed on Sep. 21, 2020.

(51) Int. Cl. G06Q 10/02; G01S 19/51

(52) U.S. Cl. CPC G06Q 10/02; G01S 19/51

(57) ABSTRACT

Automated reservation system for RV travelers that may act as a proxy for the RV traveler and make reservations for the RV traveler. RV accommodations are searched via a distributed network and identified as meeting traveler preference information. A traveler may leave standing instructions or communicate step by step instruction to reserve accommodations. Hosts proximate to the route may “bid” to host the traveler by making offers and highlighting relevant features of the accommodation. For example, if the traveler is driving an RV and needs water hookups, accommodations having space for an RV and having a water hookup may bid against each other to route the traveler to the winning accommodation. Additionally, a Sold-Out Search may be executed to allow a traveler to reserve a sold-out campground location upon a cancellation at that campground.

### CROSS-REFERENCE TO RELATED APPLICATIONS

This application claims the benefit of U.S. Provisional Application No. 63/080,815, filed on Sep. 21, 2020, as a provisional application entitled METHODS AND APPARATUS FOR HOSTING RECREATIONAL VEHICLE TRAVEL; the contents of which are incorporated herein by reference in their entirety.

### FIELD OF THE DISCLOSURE

The present invention relates to methods and apparatus for securing travel accommodations for a recreational vehicle. More specifically, the present invention discloses methods and apparatus for ascertaining variables involved in RV travel and securing appropriate reservations based upon the ascertained variables; displaying available campsites for booking based upon travel criterion, correlating those campsites with one or more images, and acting as a proxy to secure preferred RV accommodations.

### BACKGROUND OF THE DISCLOSURE

In the past, travel agencies handled most arrangements for travelers using proprietary programs exclusively available to travel agents. As use of the Internet and mobile device apps has expanded the ability for travelers to make travel arrangements has become more robust, apps such as Expedia, Airbnb and Hotels Tonight have begun providing many options to travelers. However, each of these options places the onus on the traveler to do necessary research into potential areas to which the traveler may proceed.

However, one of the benefits of motor vehicle travel, and in particular recreational vehicle (“RV”) travel, is experiencing different things that may be unique to a travel destination or stopover location. Often, a traveler will not even know what the traveler does not know about such a location. For example, an RV traveler might know the traveler wants to drive generally from Kansas City to Denver, but may not know that, by staying in the town of Salina (which is on the route from Kansas City to Denver), the World's Largest Ball of Yarn is a mere 1.5 hours away. This information may provide a more enjoyable travel experience than staying in a different stopover location. Consequently, while known methods allow a traveler to conduct research on where the traveler may stay, the traveler may not be the best person to ascertain an optimal place for a traveler to stay during RV travel.

In addition, research into potential places to stay is time consuming. RV travel is attractive because a traveler is able to observe locations the traveler passes through. If the traveler must spend time during travel to research a next stopping point, the traveler is forced to focus on a screen of some sort, such as a smart device screen and the traveler is not able to concentrate on what is all around the traveler.

Consequently, better methods and technology are needed to arrange for travel stopover locations and destinations for motor vehicle travelers and in particular RV travelers.

### SUMMARY OF THE DISCLOSURE

Accordingly, the present invention provides methods and apparatus that allow a traveler to be presented with multiple options for an upcoming stay without needing to engage in extensive research and Internet time while traveling.

The present invention allows a traveler to make available information about the traveler and the traveler's needs and for hosts to view that information and bid on hosting the traveler. The traveler may send to an automated server data indicating a general location and direction of travel, as well as traveler needs for staying at a location for one or more nights. For example, a traveler may transmit to a website resource that the traveler is travelling north on Interstate 95 in the Georgia-South Carolina area and would like to stop for 1 to 3 nights after another three or four hours of travel. In some embodiments, positional readings logged on a GPS device in the traveler's vehicle (such as, for example, GPS in a traveler's smart phone or specialized mapping device, such as a Garmin® device) may be uploaded to a website that processes the GPS positional readings and determines precisely where the traveler is and the traveler's path of travel and approximate speed of travel. The website may then extrapolate which destination areas are within the traveler's desired goal of travelling for three or four more hours on that leg of the traveler's trip.

In addition to an approximation of suitable destinations, traveler needs and “nice to haves” may be uploaded to the website. Traveler needs may include for example, one or more of: a length of a vehicle being used; types of RV hookups desired; stabilizer pads, fireplace, amenities, camp store, laundry facilities, shower facilities, Internet availability, access to nearby attractions, view from a camp site, social events at the campground, social or commercial events in the general area, and the like.

In addition to details uploaded to the website by the traveler, other information about the traveler may be included that has been aggregated by the website. Traveler information may include, by way of non-limiting example, a traveler's profession, affiliated company, travel frequency, reviews from previous hosts and/or other travelers, DMV information about vehicles involved, assessments of variables from previous hosted stays (such as, for example, audible levels (which may be subjective or measured); arrival and departure times, number of guests, use of facilities, interests, participation in onsite social events and the like.

Once posted, a potential host may view traveler details and bid on hosting the traveler. The host pitch to the traveler may include host-provided details on why a particular host is a best choice for the traveler. In addition, the host may custom-tailor its hosting offer (including, for example, a price, amenities offered, a camp site offered and the like) to address the needs and nice to haves posted by the traveler. For example, during a peak travel season, a host may charge a premium price and include only essential travel amenities; during a non-peak season, or a time the host has a relatively high number of vacancies, the host may bid a lower price and include breakfast and/cocktail hour to guest. The host may even provide tickets to an event that is occurring local to the host's facility.

Other variables that may come into play include, for example, predicted weather, wherein the host may bid to include items in their bid to address weather conditions. For example, during a rainy stay, it may be important to advertise covered areas or other sheltering available to travelers. During nice weather, other amenities, such as use of kayaks, or shuttles to trail heads, mass transit, museums, amusement parks and other local attractions may be emphasized.

Travelers have a much nicer user experience with optimum pricing availability since hosts bid under prevailing circumstances. Hosts have a better user experience since they are provided accurate insights into a current marketplace and can bid under prevailing market circumstances. Hosts also are able to view potential traveler guest profiles and history and decide whether the traveler is a fit for the hosts facility. This alone is very valuable given the lawsuits and damage caused by unruly guests that enter into short term rentals using other online apps.

Similarly, travelers may select an appropriate travel host or other accommodation provider based on one or more bids submitted to the travelers.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIGS. 1A-1B illustrate method steps that may be completed in some embodiments of the present invention.

FIG. 2 illustrates an exemplary bidding board for travel or accommodation hosts.

FIG. 3 illustrates an exemplary view of a detailed profile of a traveler on a bidding board.

FIG. 4 illustrates an exemplary view of a detailed bid to be submitted by a host to a traveler based on the traveler's parameters.

FIG. 5 illustrates an exemplary view of a board for use by travelers in determining one or more bids to accept.

FIG. 6 illustrates an automated controller that may be used to implement various aspects of the present invention.

FIG. 7 illustrates a block diagram of an exemplary mobile device.

### DETAILED DESCRIPTION

The present invention relates to method and apparatus for making reservations with a travel host, such as an Recreational Vehicle (RV) site provider, or other accommodation provider. According to the present disclosure, an RV site provider may create a profile that includes features of interest to travelers, such as relevant RV hookups, location information, nearby attractions, and other benefits relating to the traveler's engagement with the accommodation provider. Based on the traveler's travel preferences, location, speed, and projected route, the RV site accommodation provider may provide information that is received as a bid for the traveler at a location of the accommodation provider that is within an acceptable parameters for the RV'er, such as site size, utilities, distance or time from the location of the traveler. A bidding board may provide data descriptive of travelers within a certain distance and/or time from the host of other accommodation provider. The host may consider all requests for hosting bids and transmit an offer to host to the website and/or directly to the travel for the traveler to consider.

The present invention involves the traveler providing information on travel, potential destination areas (which may be broad), potential length of a stay(s), number of travelers, pets, interests, etc., allowing a host to bid on a potential stay with a made-to-order offer.

In the following sections, detailed descriptions of examples and methods of the disclosure will be given. The description of both preferred and alternative examples though thorough are exemplary only, and it is understood that to those skilled in the art that variations, modifications, and alterations may be apparent. It is therefore to be understood that the examples do not limit the broadness of the aspects of the underlying disclosure as defined by the claims.

The present disclosure refers generally to accommodations. Accommodations means, in the broadest sense, a location at which a traveler can rest, sightsee, or otherwise investigate during the pendency of a road trip (or other travel mechanism).

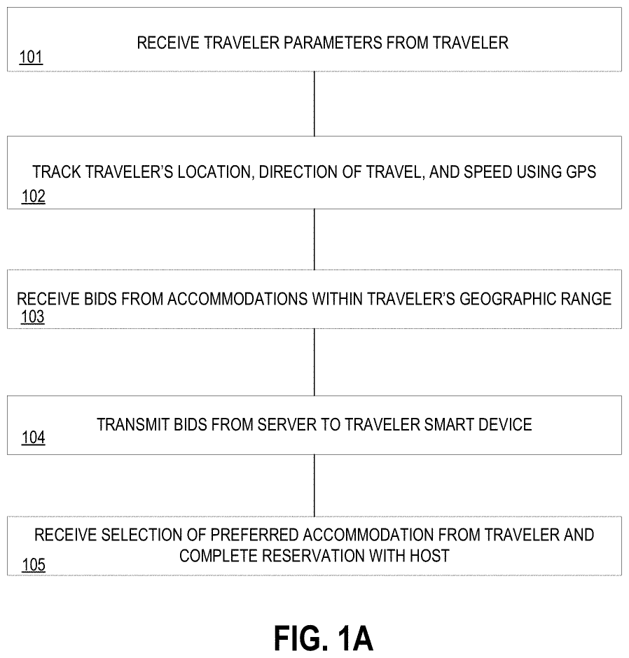

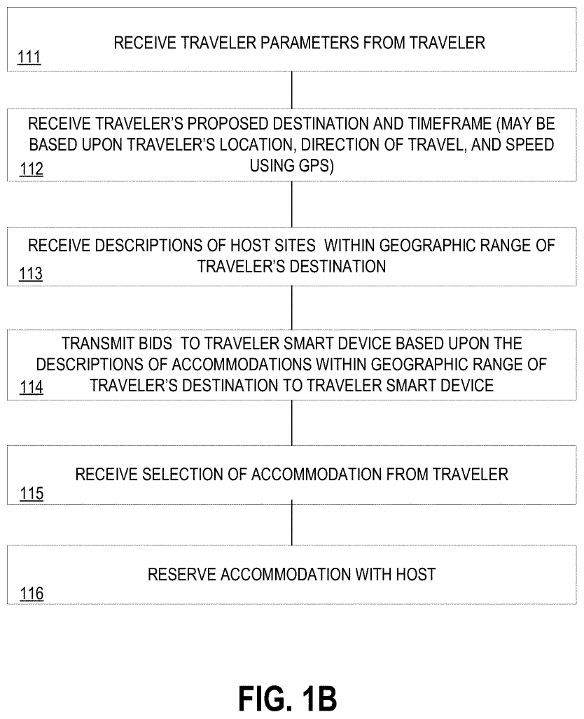

Referring now to FIG. 1A, a flowchart presenting an exemplary embodiment of the present invention is shown. According to the method shown in FIG. 1A, travelers are able to input one or more parameters related to one or more desired stopovers on a road trip (or other travel venture). One or more accommodations or services may bid on the traveler's business. The traveler may manually or automatically select the accommodation or service according to one or more bid parameters (such as price) and, in some embodiments, be automatically directed to the location of the accommodation.

At step 101, a traveler may input traveler parameters into a smart device. These parameters may then be transmitted from a smart device to a server in logical communication with the smart device and one or more accommodations. In one aspect, traveler parameters may include sufficient information for an RV Automated Reservation Provider (“RVARP”) to act as an agent for the traveler and make reservations for the traveler as if the traveler were personally interacting with a relevant accommodation provider. Traveler parameters may therefore include, by way of non-limiting example: traveler name, home address, payment information, billing address, site variable preferences, geographic preferences, account identifiers, and any other information necessary and/or preferred to make a reservation.

In another aspect, a traveler parameter may refer to information about the traveler's vehicle. For example, this may include: type of vehicle (e.g., RV, car, type of car (e.g., sedan, SUV), motorcycle, vessel, or public transit), vehicle facts (e.g., preferred type of hookup, preferred type of gas, gas mileage, vehicle size), or vehicle identifier (e.g., license plate number, make/model/color). Where the vehicle is an RV, other vehicle facts may be important, such as size, features (e.g., awning, side/rear access, expansion, or whether the RV has an attached trailer or motor vehicle), or hookups (e.g., electric, water, or wastewater).

In another aspect, a traveler parameter may relate to traveler preferences. These preferences may include, for example, road preferences, such as preferences with respect to the use or avoidance of interstate highways, scenic routes (whether or not so officially designated), multi-lane highways, or toll roads. These preferences may also include a desired travel time, such how long the traveler wishes to travel before stopping (either for a restaurant, a sight, or a place to stay for one or more nights), an amount of gas the traveler wishes to expend before stopping (which may be based on vehicle information transmitted in the previous paragraph), and whether the traveler plans to travel for one day or multiple days. The traveler may upload a planned route of travel or simply input the starting location and final location.

In still another aspect, a traveler parameter may relate to accommodation preferences. These preferences will vary based upon the type of accommodation(s) sought by the traveler, and one set of accommodation preferences may relate to the type of vendor preferred, such as: campground, hotel, truck stop, restaurant with overnight parking, private landowner, or to the available lengths of stay. This may also include whether the accommodation can store the traveler's vehicle. Where the accommodation is an RV park, the accommodation preferences may include desired hookups (such as electric, water, or wastewater). The accommodation preferences may relate to nearby amenities of the accommodation—such as recreation, food, entertainment, or attractions—or to on-site amenities of the accommodation, such as internet, pool, hot tub, spa, etc.

Where the accommodation is a restaurant, the accommodation preferences may relate to a preferred type of restaurant (American, Mexican, Japanese, etc.), a preferred food (e.g., hamburgers, ice cream, natto), a preferred price range of the restaurant (e.g., $5-$10/person, $20-$30/person), or a preferred style of restaurant (e.g., fast food, fast casual, fancy). In other embodiments, other accommodation preferences may be appropriate, such as admission price, age appropriateness, or user reviews. Other accommodation preferences may include preferences relating to the physical setting of the accommodation, such as whether it accessible to a vehicle by pulling through or backing in, whether it is near water, whether it is near bathrooms or shower facilities, whether it is shaded, whether it has a good view, whether it is secluded, or its lighting qualities (e.g., well-lit, minimal light pollution).

Still other accommodation preferences may relate to available links to other transportation types, such as the availability of rental cars or the proximity of a harbor, airport, or train station. Accommodation preferences may include vehicle services, such as vehicle repair, wash, or maintenance. Accommodation preferences may also include human services generally, such as healthcare, dental care, laundry, proximity to salons, shopping, or package pickup.

In some embodiments, a desired parameter may relate to an availability status of a campsite. For example, the traveler may wish to set up a search for campsites that are, as of the time of the search, sold out (a “Sold-Out Search”). Again, campsites are used for exemplary purposes only; other accommodations may provide Sold-Out Searches, such as restaurants.

At step 102, real-time location services such as a global positioning system (GPS) may be used to track the traveler's location, direction of travel, and speed. Additionally, if the traveler inputs the information while already on the road, a final location (for the travel day or for the trip) may be calculated based upon GPS location, direction of travel, speed, and estimated desired travel time. In some embodiments, traffic patterns may be monitored to determine traffic volumes, accidents, state-border monitoring days, and other factors that might affect travel time. In some embodiments, alternative routes may be proposed to the traveler.

Based on an inputted desired travel time or time of day to stop traveling, as modified by the aforementioned travel time factors, a geographical range (e.g., as a range of coordinates) may be determined as an approximate window at which the traveler may stop.

At step 103, the geographical range may be submitted to the server that received the traveler parameters (or another server in logical communication with that server). This range, along with one or more other relevant parameters (like accommodation type), may serve as a query to a server associated with the database. This may, in turn, prompt a subset of the relevant accommodations in the appropriate geographical range and being of the appropriate accommodation type to bid on the traveler's services based upon the other input parameters.

These bids may comprise any number of forms based upon the traveler parameters. In some embodiments, a bid score may be attributed to the bids based upon a weighted average of the traveler parameters. For example, if the traveler wants an RV park no more than ten miles off the traveler's intended route that has a water hookup, then a bid may include information relating to each accommodation provider's (1) accommodation type; (2) distance from intended route; and (3) hookup types. The bid may also include a price. Bids may be prioritized according to the extent to which the accommodation meets the traveler criteria, and then according to price, as a non-limiting example. The bid may also include an electronic brochure or other informational packet describing the other attributes of the accommodation. The bid may also include discounts, coupons (to the accommodation or to other local attractions), and a proposed duration of stay for the traveler.

Bids may have an imposed time limit. The time limit may apply to the traveler (i.e., the traveler must accept the bid within a certain amount of time) or to the prospective bidders (i.e., the bidders must transmit the bid before the traveler reaches a predetermined distance away from the accommodation nearest the traveler). In some embodiments, bids may be automatically accepted by a host based upon a predetermined threshold match score or other parameters.

In some embodiments, a host may provisionally accept a bid or other booking request. For example, in some embodiments of a Sold-Out Search, a host may automatically choose one or more travelers in response to queries. In some embodiments, these travelers may be placed on a priority list. Based upon a cancellation, the host may, at a later step, transmit a signal to a traveler's smart device indicating a cancellation and providing the traveler with a set amount of time in which to accept an offer to stay at the campsite in place of the cancelled traveler. In some embodiments, there may not be a time limit in which the traveler must accept the offer. In some embodiments, the traveler may automatically accept the offer. In this way, a user can input a proposed destination (e.g., Glacier National Park) and automatically accept any sold-out campsites that unexpectedly have an opening due to a cancellation.

At step 104, the bids are transmitted from the server to the traveler's smart device. In some embodiments, software on the smart device may be operative to read each bid aloud, to ensure the traveler does not need to take the traveler's eyes off the road. As stated above, the bids may have a time limit associated with them.

At step 105, an accommodation is selected by the traveler. This selection may be transmitted from the traveler's smart device to the accommodation via the server. In some embodiments, the traveler's selection constitutes a binding acceptance of the accommodation's terms. In some embodiments, the smart device may store credit card information (or other payment information) for transmittal to the accommodation for prompt payment processing. In some embodiments, if the winning accommodation's bid was accompanied by other perks (e.g., coupons to nearby attractions), then those perks may be transmitted to the traveler's smart device upon acceptance of the accommodation's bid. For example, if the winning bid was an offer for the traveler to stay at a certain RV park three hours away, but a popular theme park sat between the traveler and the RV park, the RV park might incentivize customers by including coupons to admissions to that theme park. Those coupons might be transmitted to the traveler's smart phone to allow the traveler to take advantage of that perk prior to reaching the RV park.

Referring now to FIG. 1B, a second flowchart lists exemplary method steps that may be performed in some embodiments of the present invention is shown. Generally, travelers input one or more parameters related to an area of destination for a given date or dates. A computer server matches traveler parameters with potential travel hosts and arrange a travel stay based upon a traveler response.

At step 111, a traveler smart device transmits traveler parameters to a server, such as a cloud server. For example, the parameters may be transmitted from a smart device to the server via logical communication across a digital communications network, such as the Internet. Traveler parameters may include information about the traveler's vehicle, site preferences, pricing range, amenities or related factors, such as those described in relation to FIGS. 1A-1B above. Accordingly, preferences may include, for example, road preferences, such as preferences with respect to the use or avoidance of interstate highways, scenic routes (whether or not so officially designated), multi-lane highways, or toll roads; a desired travel time, such how long the traveler wishes to travel before stopping (either for a restaurant, a sight, or a place to stay for one or more nights), a type of accommodation sought by the traveler, such as: a campground, a hotel, a truck stop, restaurant with overnight parking, private landowner; an available length of stay; nearby amenities, food, entertainment, or attractions—or to on-site amenities of a host site, such as internet, pool, hot tub, spa, etc.

At step 112, the traveler's destination for a particular day may be received into a server communicating with the traveler. The destination may be based upon one or both of: traveler input indicating the destination; real-time location services such as a global positioning system (GPS) that are used to track the traveler's location, direction of travel, and speed. Additionally, if the traveler inputs the information while already on the road, a final location (for the travel day or for the trip) may be calculated based upon GPS location, direction of travel, speed, and estimated desired travel time. In some embodiments, traffic patterns may be monitored to determine traffic volumes, accidents, state-border monitoring days, and other factors that might affect travel time. In some embodiments, alternative routes may be proposed to the traveler.

At step 113, the server may receive a description of one or more host sites within range of the designated traveler destination. The descriptions of host sites may be received on a periodic based, such as twice daily, weekly, etc. Preferably the descriptions of available host sites are received automatically on a defined periodic basis. For example, a server may poll a listing of available host accommodations (or otherwise receive an electronic communication) indicating which accommodations are available and when and for what cost. In addition, a logical process may indicate which host accommodations are within a traveler designated acceptable travel range. For example, a traveler may indicate a preferred destination and an acceptable travel range of 100 miles, in which case any host accommodation within 100 miles of the preferred travel destination will be considered acceptable. In some embodiments, the received description may also include one or more photographs. These photographs may be obtained from the host site's website. The photographs may also be obtained from automatically conducted searches of publicly available websites. For example, when receiving a description, the server may transmit a signal to Google Image Search comprising the name of the host site. The server may then retrieve an image result (such as the top image result) from the Google Image Search.

The acceptable travel range may be submitted to the server that received the traveler parameters (or another server in logical communication with that server). The acceptable travel range, along with one or more other relevant parameters (like accommodation type), may serve as a query to a server associated with the database.

At step 114, bids may presented to the traveler, via digital content communicated to a smart device associated with the traveler The bid may also include proposed transaction details, such as duration, price, description, images, and included amenities. In some embodiments, bids may be prioritized according to the extent to which the accommodation meets the traveler criteria, and then according to price, as a non-limiting example. A bid may also include electronic content conditions and attributes of the accommodation. A bid may also include discounts, coupons (to the accommodation or to other local attractions), and a proposed duration of stay for the traveler.

In some embodiments, a bid may have an imposed time limit. The time limit may apply to the traveler (i.e., the traveler must accept the bid within a certain amount of time) or to the prospective bidders (i.e., the bidders must transmit the bid before the traveler reaches a predetermined distance away from the accommodation nearest the traveler). In the case of a Sold-Out Search, the bid may transition to a subsequent potential traveler if the original traveler does not accept the bid within a set amount of time.

Digital content related to a proposed stay at a host accommodation, including bid details may be transmitted from the server to the traveler's smart device. In some embodiments, software on the smart device may be operative to read each bid aloud, to ensure the traveler does not need to take the traveler's eyes off the road. As stated above, the bids may have a time limit associated with them, bids may have no time limit, or bids may be accepted automatically.

At step 115, a digital communication is received indicating an accommodation selected by the traveler. This digital communication with the accommodation selection may be transmitted from the traveler's smart device to the accommodation via the server. In some embodiments, the traveler's selection constitutes a binding acceptance of the accommodation's terms. In some embodiments, the smart device may store credit card information (or other payment information) for transmittal to the accommodation for prompt payment processing. In some embodiments, if the winning accommodation's bid was accompanied by other perks (e.g., coupons to nearby attractions), then those perks may be transmitted to the traveler's smart device upon acceptance of the accommodation's bid.

At step 116, the server, may transmit a communication causing one or more host accommodations to be reserved for the traveler based upon the content of the digital communication received in step 115.

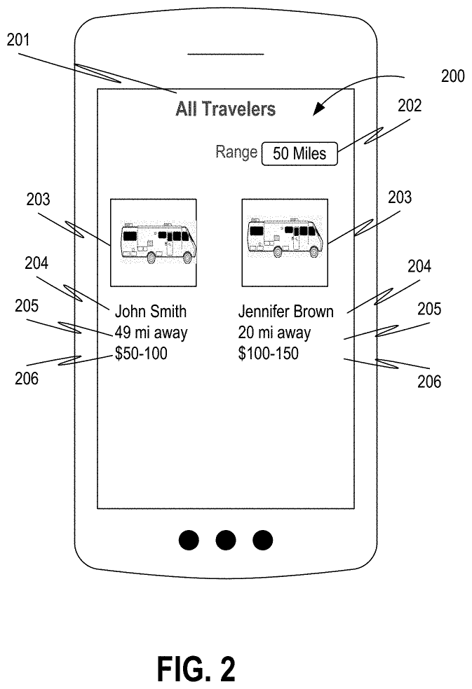

Referring now to FIG. 2, an exemplary bidding board 200 is shown. The view reflected in FIG. 2 is one that might be shown to an accommodation provider. This view comprises, among other things, traveler type 201. Traveler type 201 may be a selectable (i.e., via drop-down menu) was to allow the accommodation provider to filter out one or more categories of traveler to whom the accommodation provider wishes to offer its services or to place a bid. In some views, the accommodation provider may wish to view all travelers (subject to other potential filters, such as distance filter 202). In other views, the accommodation provider may wish to view all travelers according to a certain criteria, such as: vehicle type, desired accommodation type, travelers who have indicated features of the accommodation provider that the travelers wish to have in their accommodation location (e.g., if a traveler has indicated that the traveler wishes to have lodging with a scenic view, then an accommodation provider with an accommodation having a scenic view would be able to view only those travelers seeking a scenic view), and the like.

Additional filters may also be useful in some embodiments. For example, the embodiment shown in FIG. 2 includes distance filter 202. Distance filter may allow an accommodation provider to view only travelers who are a certain distance, time, or other measure away from the location of the accommodation provider. Other additional filters may include traveler preferences, traveler criteria, vehicle type, or other means of generating a subset of suitable travelers from the set of all active travelers (or a subset thereof).

Travelers who meet any filtering criteria may be displayed on bidding board 200 in any suitable view, such as a profile view of a traveler. In the non-limiting example shown in FIG. 2, the profile view of the traveler comprises picture 203, name 204, distance 205, and traveler preference 206. Picture 203 may be an image associated with the traveler, such as an image selected by the traveler or an image associated with the traveler's vehicle (such as one automatically retrieved from an image database or other repository). A traveler name 204 may also be displayed. This may be a real name, a family name, a user name, or any other suitable identifier. A distance 205 associated with the traveler may also be displayed. Distance 205 may comprise a real-time (or approximately real-time) estimate of the distance between the traveler and the accommodation provider. Specifically, this may be measured by determining a GPS location of the accommodation provider (based on a GPS device proximate to the accommodation provider, internet connectivity details, Wi-Fi connectivity details, etc.) and comparing it with a GPS location of the traveler. Distance 205 may also be associated with an approximate time of arrival by using any of: measurements of the traveler's velocity (which may also be determined by GPS) or known mapping and route-planning software.

The profile view may also comprise traveler preference 206. In the exemplary embodiment shown in FIG. 2, traveler preference 206 comprises a desired price range for the traveler (i.e., an approximate amount of money the traveler would like to spend with the accommodation provider). However, any of the other traveler preferences or parameters discussed above may also be suitable for inclusion here. For example, it may be desirable to display a vehicle type associated with the traveler. It may also be desirable to display a preferred lodging or restaurant type associated with the traveler. Moreover, in some embodiments, multiple traveler preferences 206 may be displayed. This may depend on the particular embodiment, implementation, accommodation-provider device, etc.

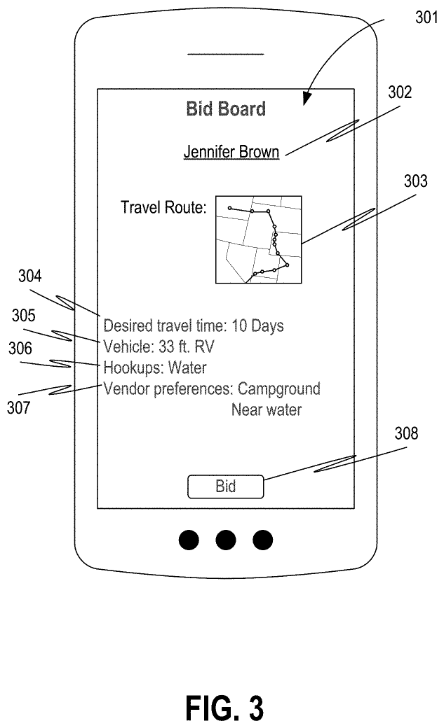

Referring now to FIG. 3, an exemplary view of a detailed profile 301 of a traveler is shown. Detailed profile 301 comprises a name of the traveler 302, a travel route associated with the traveler 303, other parameters 304-307, and bid button 308. As with name 204, name 302 may be a real name, a family name, a user name, or any other suitable identifier. Other parameters 304-307 may be useful parameters for determining whether to bid on the traveler. The examples shown in FIG. 3 are not meant to be limiting. In FIG. 3, the parameters are: desired travel time 304, information about vehicle 305, needed hookups 306, and vendor preferences 307. Desired travel time may be expressed in terms of the overall trip (e.g., from start to finish, the traveler wants the trip to take ten days), a day within the trip (e.g., the traveler would like to be on the road for five more hours before stopping), or a subset of the foregoing. A travel route may be displayed as well, including via map, as shown in travel route 300. Additionally, there bid button 308 may allow the accommodation provider to submit a bid (further discussed below) on user 302.

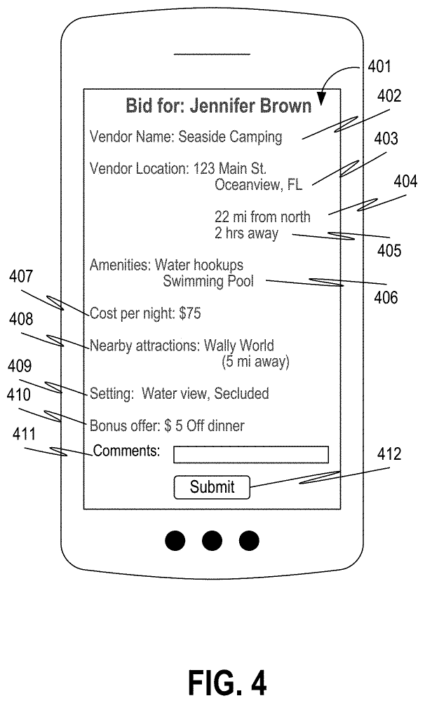

Referring now to FIG. 4, an exemplary view of a prepared bid 401 for a user is shown. This screen may be shown to an accommodation provider preparing to submit a bid, or to a traveler evaluating whether to accept a bid. FIG. 4 shows exemplary, non-limiting examples of aspects that may be included with a bid. For example, prepared bid 401 as shown includes a vendor name 402, along with a location 403 associated with the vendor, such as an address. Other means of location identification include an approximate distance from the traveler's route 404 (based on, in some embodiments, a point of closest approach between the route and the accommodation) or an associated amount of time 405. The associated amount of time 405 may be determined by receiving a communication from a GPS associated with the traveler or the accommodation provider.

Prepared bid 401 may further include one or more amenities 406. These amenities 406 may be all amenities offered by the accommodation or a subset of amenities offered by the accommodation. In the latter case, the subset may be determined based upon one or more of: user reviews, accommodation provider prioritization, or matches between traveler-prioritized amenities and accommodation provider-prioritized amenities (for example, if the traveler is seeking water hookups, a pool, and a scenic view, and the accommodation provider offers water hookups, a pool, and a bowling alley, then amenities 406 may display water hookups and a pool).

Prepared bid 401 may also include approximate cost 407 of the accommodation. For example, where the accommodation is a lodging, then approximate cost 407 may relate to a nightly cost of staying at the lodging. As another example, where the accommodation is a restaurant, then approximate cost 407 may relate to an approximate cost of a meal at the restaurant.

Prepared bid 401 may also include other useful information for the traveler, such as nearby attractions 408, setting 409, and bonus offer 410. Nearby attractions 408 may relate to attractions of interest to the traveler within a certain distance of the accommodation. For example, if the traveler has indicated a distance in sightseeing, amusement parks, and spas, then nearby attractions 408 may include one or more sightseeing destinations, amusement parks, or spas within a certain distance of the accommodation. In some embodiments, either the accommodation provider or the traveler may input a desired distance or time away from the accommodation to filter nearby attractions 408.

Prepared bid 401 may also include setting 409. This may describe features of the accommodation based upon input from an accommodation provider, traveler, or other travels. For example, FIG. 4 describes Seaside Camping's setting as water view and secluded. Other examples of settings may include, without limitation, scenic views, busy, rural, urban, suburban, rustic, mountain view, forest view, canyon view, fjord view, etc.

Prepared bid 401 may also include bonus offer 410. In some embodiments, to further entice travelers to come to the accommodation, an accommodation provider may make arrangements with a nearby attraction, on-site facilities, or others to provide additional incentives for the traveler to visit the accommodation provider. For example, a bonus offer 410 might include a discount on a meal, a discount on an attraction, or vouchers for on-site facilities (such as a spa, casino, restaurant, or bar).

Prepared bid 401 may also include miscellaneous comments 412 from the accommodation provider. Comments 412 may include a personalized message to the traveler, additional information about the accommodation, contact information, and the like. Once an accommodation provider has finalized prepared bid 401, then an input like submit button 412 may be provided to allow the accommodation provider to submit the bid to a pool of bids from which the traveler may choose.

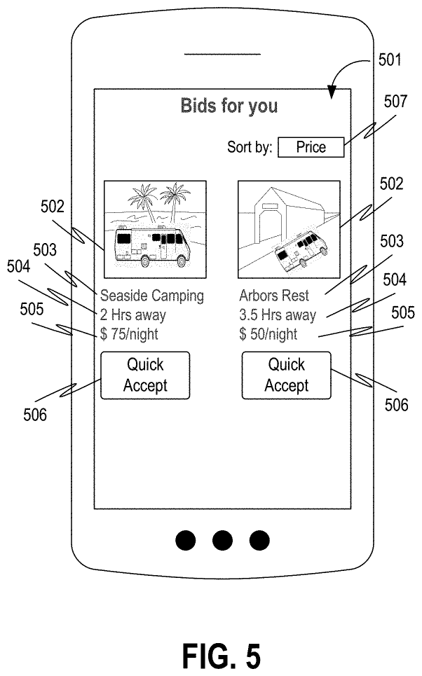

Referring now to FIG. 5, an exemplary traveler-side view 501 of a bid board is shown. This view may reflect a view shown to a traveler when choosing among various bids on the traveler's business. The view shown in FIG. 5 shows two competing bids. Each bid comprises a picture 502 of the accommodation, a name 503 associated with the accommodation, a travel time 504 between the traveler's then-current position and the accommodation location, and an approximate cost 505. Picture 502 may be based on an image chosen by the accommodation provider, an image chosen by users, an image chosen by an accommodation-reviews entity, or any other suitable image. Travel time 504 may be based on a GPS transmission (or other wireless location information transmission) between the traveler and the accommodation provider. It may also be based on input from the traveler's vehicle's speedometer or other speed-determining means. As with approximate cost 407, approximate cost 505 may be based on the type of accommodation and may be determined with reference to specifications of the accommodation provider (e.g., a predetermined input as to the nightly cost of a lodging), average prices charged by other reviewers, etc.

If the traveler is offered more than one bid, then these bids may be sortable by sort criterion 507. Sort criterion 507 may include, by way of non-limiting example, price, distance, ratings, or a custom sorting based upon a weighting of traveler criteria. For example, the traveler might prioritize price over available hookups, and available hookups over distance, but by inputting a custom weighting, the traveler may be able to sort in a way that puts a cheap, proximate accommodation without the requisite hookups.

Additionally, the traveler may have an option to execute a quick accept 506 on one or more bids. This may be especially useful where the traveler is a driver and cannot safely review detailed information on the traveler's smart phone. On the other hand, other interactive aspects of the board may allow the traveler to review more detailed specifications relating to the bid. For example, the traveler might be able to “click” picture 502 to be taken to a view similar to that of the view shown in FIG. 4: a detailed bid.

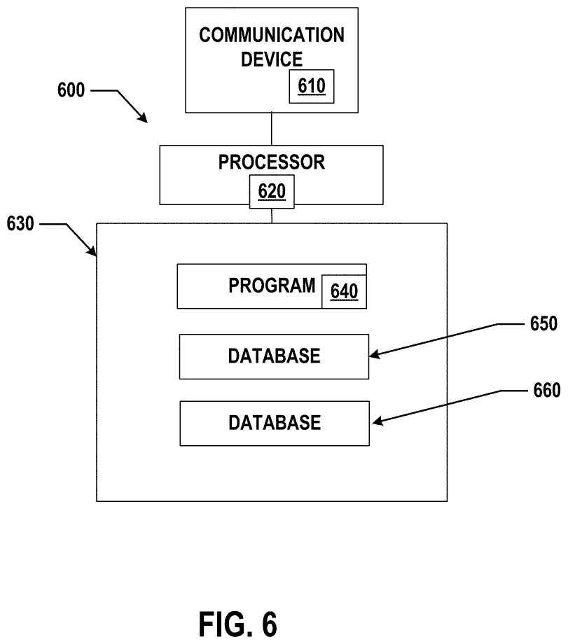

Referring now to FIG. 6, an automated controller is illustrated that may be used to implement various aspects of the present invention, in various embodiments, and for various aspects of the present invention, controller 600 may be included in one or more of: a wireless tablet or handheld device, a server, a rack mounted processor unit. The controller may be included in one or more of the apparatus described above, such as a Server, and a Network Access Device. The controller 600 includes a processor unit 620, such as one or more semiconductor-based processors, coupled to a communication device 610 configured to communicate via a communication network (not shown in FIG. 6). The communication device 610 may be used to communicate, for example, with one or more online devices, such as a personal computer, laptop, or a handheld device.

The processor 620 is also in communication with a storage device 630. The storage device 630 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 630 can store a software program 640 with executable logic for controlling the processor 620. The processor 620 performs instructions of the software program 640, and thereby operates in accordance with the present invention. The processor 620 may also cause the communication device 610 to transmit information, including, in some instances, control commands to operate apparatus to implement the processes described above. The storage device 630 can additionally store related data in a database 650 and database 660, as needed.

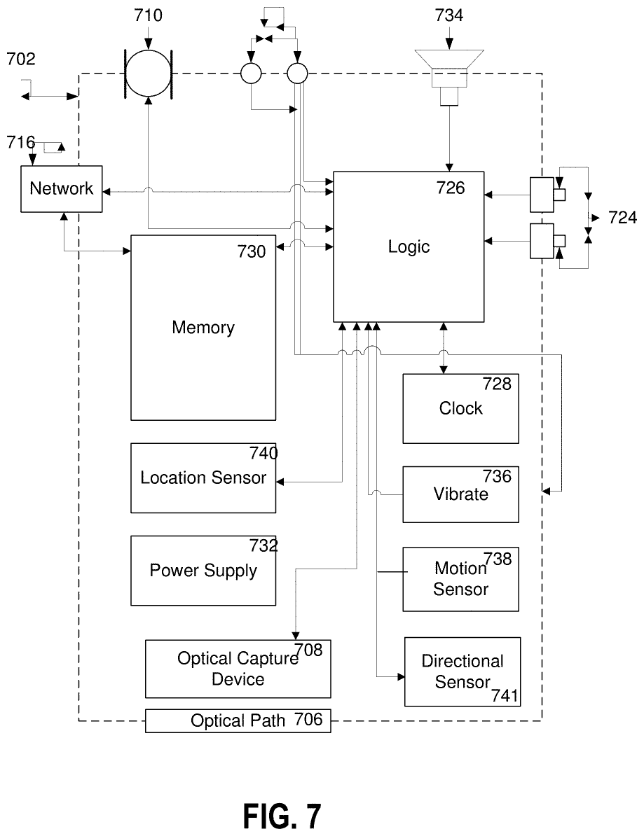

Referring now to FIG. 7, a block diagram of an exemplary mobile device 702. The mobile device 702 comprises an optical capture device 708 to capture an image and convert it to machine-compatible data, and an optical path 706, typically a lens, an aperture or an image conduit to convey the image from the rendered document to the optical capture device 708. The optical capture device 708 may incorporate a charge-coupled device (CCD), a complementary metal oxide semiconductor (CMOS) imaging device, or an optical sensor 724 of another type.

A microphone 710 and associated circuitry may convert the sound of the environment, including spoken words, into machine-compatible signals. Input facilities may exist in the form of buttons, scroll wheels, or other tactile Sensors such as touch-pads. In some embodiments, input facilities may include a touchscreen display.

Visual feedback to the user is possible through a visual display, touchscreen display, or indicator lights. Audible feedback 734 may come from a loudspeaker or other audio transducer. Tactile feedback may come from a vibrate module 736.

A motion sensor 738 and associated circuitry convert the motion of the mobile device 702 into machine-compatible signals. The motion sensor 738 may comprise an accelerometer that may be used to sense measurable physical acceleration, orientation, vibration, and other movements. In some embodiments, motion sensor 738 may include a gyroscope or other device to sense different motions.

A location sensor 740 and associated circuitry may be used to determine the location of the device. The location sensor 740 may detect GPS radio signals from satellites or may also use assisted GPS where the mobile device may use a cellular network to decrease the time necessary to determine location. In some embodiments, the location Sensor 740 may use radio waves to determine the distance from known radio sources such as cellular towers to determine the location of the mobile device 702. In some embodiments these radio signals may be used in addition to GPS.

The mobile device 702 comprises logic 726 to interact with the various other components, possibly processing the received signals into different formats and/or interpretations. Logic 726 may be operable to read and write data and program instructions stored in associated storage or memory 730 such as RAM, ROM, flash, or other suitable memory. It may read a time signal from the clock unit 728. In some embodiments, the mobile device 702 may have an on-board power supply 732. In other embodiments, the mobile device 702 may be powered from a tethered connection to another device, such as a Universal Serial Bus (USB) connection.

The mobile device 702 also includes a network interface 716 to communicate data to a network and/or an associated computing device. Network interface 716 may provide two-way data communication. For example, network interface 716 may operate according to the internet protocol. As another example, network interface 716 may be a local area network (LAN) card allowing a data communication connection to a compatible LAN. As another example, network interface 716 may be a cellular antenna and associated circuitry which may allow the mobile device to communicate over standard wireless data communication networks. In some implementations, network interface 716 may include a universal serial bus (USB) to supply power or transmit data. In some embodiments other wireless links may also be implemented.

A directional sensor 741 may also be incorporated into the mobile device 702. The directional device may be a compass and be based upon a magnetic reading or based upon network settings.

### CONCLUSION

A number of embodiments of the present disclosure have been described. While this specification contains many specific implementation details, there should not be construed as limitations on the scope of any disclosures or of what may be claimed, but rather as descriptions of features specific to particular embodiments of the present disclosure. While embodiments of the present disclosure are described herein by way of example using several illustrative drawings, those skilled in the art will recognize the present disclosure is not limited to the embodiments or drawings described. It should be understood the drawings and the detailed description thereto are not intended to limit the present disclosure to the form disclosed, but to the contrary, the present disclosure is to cover all modification, equivalents and alternatives falling within the spirit and scope of embodiments of the present disclosure as defined by the appended claims. For example, while the present disclosure speaks generally in terms of RV campgrounds (and their respective functionalities, such as hookup points), other embodiments are within the scope of the present invention. In some embodiments, an accommodation may include a hotel, motel, attraction, restaurant, vehicle service, or other desirable stopping point.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising”, “including”, and “having” can be used interchangeably.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while method steps may be depicted in the drawings in a particular order, this should not be understood as requiring that such operations be performed in the particular order shown or in a sequential order, or that all illustrated operations be performed, to achieve desirable results.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A method for improving smart device performance in selection of an accommodation while traveling, the method comprising the steps of:
a. receiving from a traveler smart device, a traveler parameter comprising an accommodation preference;
b. receiving from the traveler smart device a destination and a timeframe or arrival of an RV to a potential RV accommodation;
c. searching a distributed network for
d. transmitting a multiple bids from a host to a traveler smart device based upon the traveler parameter, destination, and timeframe;
e. receiving from the traveler smart device, a selection of a preferred accommodation;
f. transmitting to the host a request to reserve the preferred accommodation; and
g. interacting with a host reservation system to complete a reservation for the preferred accommodation.

2. The method of claim 1, wherein the accommodation preference comprises an availability status corresponding to the host, and the method further comprises the step of transmitting a notification to the traveler smart device of a change in the availability status.

3. The method of claim 1, wherein the step of receiving a destination occurs by receiving a GPS signal from the traveler smart device.

4. The method of claim 1, wherein the destination is determined by the steps of: (i) receiving a current GPS location; (ii) receiving a direction of travel of the traveler smart device; (iii) receiving a speed of movement of the traveler device; (iv) receiving a range in which the traveler would like to stop traveling; and (v) calculating an approximate destination range based upon the current GPS location, direction of travel, and speed.

5. The method of claim 1, wherein the accommodation preference is a type of hookup required by a vehicle of the traveler.

6. The method of claim 1, wherein the accommodation preference is a feature of the accommodation.

7. The method of claim 1, further comprising the steps of:
f. transmitting a second bid from a second host to a traveler smart device based upon the traveler parameter, destination, and timeframe; and
g. sorting the first bid and the second bid based upon a predetermined sorting criterion.

8. The method of claim 7, wherein the method further comprises the step of causing the traveler smart device to display a first and second profile associated with each of the first and second bids respectively.

9. The method of claim 8, further comprising the step of causing the first and second profile to be associated with a “quick accept” button to allow a user to choose between the first and second profile with minimal distraction.

10. The method of claim 1, further comprising the step of transmitting a bonus offer associated with a secondary accommodation proximate to the accommodation.

11. An apparatus for improved performance in selection of an accommodation while traveling, the apparatus comprising:
a. a processor;
b. a communications device; and
c. memory comprising software executable on demand, the software operative to cause the apparatus to, via the communications device:
i. receive from a traveler parameter, comprising an accommodation preference, from a traveler smart device;
ii. receive a destination and a timeframe from the traveler smart device;
iii. transmit a first bid from a host to a traveler smart device based upon the traveler parameter, destination, and timeframe;
iv. receive a selection of accommodation from the traveler smart device; and
v. transmit to the host a confirmation of the selection.

12. The apparatus of claim 11, wherein the accommodation preference comprises an availability status corresponding to the host, and the software is further operative to cause the apparatus to transmit, via the communications device, a change in the availability status.

13. The apparatus of claim 11, wherein the software is operative to cause the apparatus to receive via the communication device a GPS signal from the traveler smart device.

14. The apparatus of claim 11, wherein the destination is a timeframe determined by the processor by the steps of: (i) receiving a current GPS location; (ii) receiving a direction of travel of the traveler smart device; (iii) receiving a speed of movement of the traveler device; (iv) receiving a range in which the traveler would like to stop traveling; and (v) calculating an approximate destination range based upon the current GPS location, direction of travel, and speed.

15. The apparatus of claim 11, wherein the accommodation preference is a type of hookup required by a vehicle of the traveler.

16. The apparatus of claim 11, wherein the accommodation preference is a feature of the accommodation.

17. The apparatus of claim 11, wherein the software is further operative to cause the apparatus to:
i. transmit a second bid from a second host to a traveler smart device based upon the traveler parameter, destination, and timeframe; and
ii. sort the first and the second bid based upon a predetermined sorting criterion.

18. The apparatus of claim 17, wherein the software is further operative to transmit a signal to the traveler smart device causing the traveler smart device to display a first and second profile associated with each of the first and second bids respectively.

19. The apparatus of claim 18, wherein the software is further operative to cause the first and second profile to be associated with a “quick accept” button to allow a user to choose between the first and second profile with minimal distraction.

20. The apparatus of claim 11, wherein the software is further operative to cause the apparatus to transmit, via the communications device, a bonus offer associated with a secondary accommodation proximate to the accommodation.
